(19) United States
(12) Patent Application Publication
(10) Pub. No.: US 2009/0290468 A1
(43) Pub. Date: Nov. 26, 2009

(54) INFORMATION REPRODUCING METHOD

(75) Inventor: Maarten Kuijper, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,474

(22) PCT Filed: Dec. 12, 2005
(86) PCT No.: PCT/IB2005/054180

§ 371 Date: Jun. 12, 2007

(30) Foreign Application Priority Data
Dec. 20, 2004 (EP) 04106730.7

(51) Int. Cl. G11B 7/00

(52) U.S. Cl. 369/100; G9B/7

(57) ABSTRACT

The present invention relates to an information reproducing method for reproducing information recorded on an information recording carrier with several information layers by radiating light onto the carrier being e.g. an optical disc. The method comprises the step of 1) focusing the light at a first information layer or a second information layer, where the first layer and the second layer are adjacently positioned in the information recording carrier, 2) performing radial tracking on the reflected light from the information recording carrier, and 3) assessing form the radial tracking if the light is focussed on a clockwise or a counter-clockwise oriented spiral relative to the focussed light. In a particular embodiment, the assessment of whether the light is focussed on a clockwise or a counter-clockwise oriented spiral relative the light is utilized for indicating the identity of the layer on which the light is focussed. The invention also relates to an optical apparatus for implementing the method of the invention.

The present invention relates to an information reproducing method for reproducing information recorded on an information recording carrier with several information layers by radiating light onto the carrier, the carrier being e.g. an optical disc. The invention also relates to an optical apparatus comprising means for implementing the information reproducing method.

In order to meet the demand of increasing information storage capacity the available optical media, presently e.g. digital versatile disc (DVD) and the Blu-ray Disc (BD), show a constant improvement in storage capacity. Dual-layer optical media or even multi-layer optical media has also been introduced to further increase the storage capacity.

Recording and reproducing information in dual-layer media and in particular multi-layer media forms a technical challenge as the optical hardware must be adapted for essentially an extra dimension of variation. A particular problem is that the specific identification of the layer number should be retrievable before reading and/or writing information to the layer. Optical discs conventionally have their information organized in sectors that is the smallest unit that can be recorded on a disc. Each sector has a header region containing information about the actual physical location of the data, i.e. physical identification data (PID), a data region, and an error correction code region (ECC). The header region may accordingly contain information about the layer number but this leads to a redundancy, as the layer number is stored in every sector header. Alternatively or additionally, sector and layer information may be stored in a wobble on a groove track or in pre-pits.

Alternatively, a method for identifying an information layer of an dual layer optical disc by using an increase or decrease in the physical address and recorded address is known from e.g. US 2002/0176346. Thus, by the organization of the addresses the layer identity may be inherently stored obviating the need for storaging the layer identity itself. The method may be applied for disc wherein the first and second information layers are disposed in a concentric spiral, either with the same or opposite spiral track direction. In the BD disc standard, the dual layer discs have their spirals oriented in opposite track directions to minimize transition time between the two layers.

However, this method requires that the optical apparatus reproducing information from the optical disc has already optimized the information reproduction. The reproduction includes preliminary steps like disc type recognition, spherical aberration compensation, optimizing closed radial loop tracking to enable signal read-out, deciding tracking polarity, attempting to read address in pre-groove (ADIP) and repeated optimized spherical aberration compensation. These steps must be finished before the actual layer identification can be achieved, and this may be relatively time consuming because some preliminary steps has to be done in a trial-and-error fashion if the actual layer is unknown. Therefore, the preliminary steps before information reproduction could potentially be accelerated if knowledge about the layer number was present before, e.g. the repeated spherical aberration compensation, the decision about the tracking polarity and the presetting of the layer dependent focus offset may be faster if the actual layer number was known.

US 2004/0095860 discloses a method wherein a spherical aberration signal is detected as a differential signal between focus position fluctuation signals respectively in a central position and in a peripheral section of a reproduced flux of light. An information layer is discriminated using a quantity of correction of spherical aberration at a zero-crossing point of a level or a spherical aberration signal associated with the differential signal. Thus, by this method the identity of the layer is obtainable about the identity of the layer without reproducing information from the layer itself. However, this method has the drawback that to generate a spherical aberration signal there should be provided additional optical components and electric circuits, thus the proposed method is relatively expensive and/or complicated to implement.

Hence, an improved information reproducing method would be advantageous, and in particular a faster and/or reliable information reproducing method would be advantageous.

Accordingly, the invention preferably seeks to mitigate, alleviate or eliminate one or more of the above mentioned disadvantages singly or in any combination. In particular, it may be seen as an object of the present invention to provide an information reproducing method that solves the above mentioned problems of the prior art with identifying the layer in a multi-layer information recording carrier.

This object and several other objects are obtained in a first aspect of the invention by an information reproducing method of reproducing information recorded on an information recording carrier, the carrier having a plurality of information layers, each layer having information arranged in one or more substantially concentric spiral(s), by radiating light onto the information recording carrier, the method comprising the steps of:
focusing the light at a first information layer or a second information layer, said first layer and said second layer being adjacently positioned in the information recording carrier,
performing radial tracking on the reflected light from the information recording carrier, and
assessing from said radial tracking if the light is focussed on a clockwise or a counter-clockwise oriented spiral relative to the light.

The invention is particularly but not exclusively advantageous for obtaining the orientation of a spiral in information layer relative to the incoming light beam. The orientation of the spiral may for e.g. a dual-layer information recording carrier with the first layer and second layer of information being disposed in two spirals oriented in the opposite track direction relative to each other be applied to obtain the identification of the information layer directly and absolutely. Thus, for a dual-layer with opposite orientation of the first layer and the second layer of information the present invention may provide knowledge of the orientation of the layer that the light is focussed on, and because the first layer and second layer of information have opposite oriented spiral the layers may readily be distinguished. This is quite beneficial for any preliminary steps prior to information reproducing that may be accelerated if the identity of the information layer is known, e.g. trial-and-error processes of the preliminary steps may be shorted or even eliminated. The present invention may be applied for a variety of information recording carrier types, such as read-only-memory (ROM), write-once-read-many (WORM), or rewriteable (RE).

The present invention is, however, not limited to dual-layer carriers and the principle of the invention may also be applied for a multi-layered information recording carrier, i.e. carriers with three, four, five or more layers of information. As the method of the present invention enables assessment of the relative orientation of the spiral of information, i.e. either a clockwise or a counter-clockwise orientation, there are two possible outcomes of the assessment. With three or more layers in a carrier the possible outcomes of the spiral orientation may therefore not be sufficient for determining the layer identity in an absolute manner. Nevertheless, the present invention may still be advantageously adapted for layer identification for a multi-layered information recording carrier. Firstly, with for example three layers of information, there may be a middle layer of information with a spiral orientation opposite the spiral orientations of the upper and lower layer of information. Thus, at least the middle layer may be identified in an absolute way by the present invention.

Secondly, there may be situations for a multi-layered information recording carrier where it is sufficient to distinguish between two layers, if for example there is already an expectation or knowledge that the light is focussed on one of two layers in the multi-layered information recording carrier, but it is unknown which specific layer of the said two layers the light is focussed on. Thus, within the context of the present inventions a relative identity is also understood as providing an indicative of the layer identity as the method of the invention may be applied to discriminate between two or more layers.

The step of focusing the light at a first information layer or a second information layer may be a result of an arbitrary choice or deliberate choice depending on the situation. Even in the case of a deliberate chosen capture-layer a check needs to be done to confirm the focus capture was successful. Additionally, the present invention is not limited to use during preliminary steps prior to information reproduction/recording at start-up, rather the invention may also be applied during control procedures e.g. procedures shortly interrupting information reproduction/recording, and in recovery situations, i.e. when an optical drive has a malfunction caused by either internal or external influence that necessitates a renewed layer identification.

Each layer of information may comprise one or more spirals, the one or more spirals of a layer comprises optical readable effect e.g. pits or marks for storage of the information. The one or more spirals of a layer preferable have the same orientation but may also have opposite orientations. Thus, the present invention may accordingly also assess the various spiral orientations within a layer and accordingly be used to aid in determining the spiral identity.

The method may further comprise an initial step of compensating for optical aberration at a position in the optical record carrier in-between said first layer and said second layer by collimating means, e.g. dedicated lenses. This may advantageously be performed to compensate and/or eliminate spherical aberration resulting from the cover and/or intermediate layers of the carrier. This may also eliminate or compensate for focus offset. The position for the optical aberration compensation may be substantially in a middle position relative to said first layer and said second layer of information.

The step of assessing from said radial tracking if the light is focussed on a clockwise or a counter-clockwise oriented spiral relative to the light may comprise measuring of an incremental radial displacement of the relative position of the focussed light on the information recording carrier. The incremental radial displacement may advantageously be measured by radial integration means. Alternatively or additionally, the incremental radial displacement may be measured from actuation means adapted for displacing the relative position of the light on the information recording carrier, e.g. by measuring a current or a voltage associated with or controlling said actuation means.

The measured incremental radial displacement may advantageously be averaged over at least one revolution of the information recording carrier in order to stabilize the obtained values of the incremental radial displacement. Moreover, if the spiral disposed on the carrier has an eccentricity, such as eccentricity may be cancelled or taken into account in the assessment of the incremental radial displacement

The invention is particularly advantageous in that the performed radial tracking may be based on a radial tracking method from the non-exhaustive group of: push-pull (PP), differential push-pull (DPP) and differential phase detection (DPD). Other methods for radial tracking may also readily be incorporated into or adapted to function according to the present invention.

In a particular embodiment, at least one spiral of the first layer and at least one spiral of the second layer are oriented in opposite directions relative to the light, e.g. one spiral is clockwise and a second spiral is counter-clockwise oriented. This is for example the present situation of the dual-layer BD standard. Thus, the present invention is readily applied to and incorporated in well-known standards.

In the context of the present invention, the orientation of a spiral is assessed relative to the focussing light, said light normally having a beam direction perpendicular to a plane of the carrier, but equivalently the orientation of a spiral may be assessed relative to a fixed viewing position, e.g. from one side of the carrier.

In a second aspect, the invention relates to an optical apparatus for reproducing information recorded on a information recording carrier, the optical apparatus being adapted for reproducing and/or recording information from/to an optical information carrier, the optical apparatus comprising:
means for focusing the light at a first information layer or a second information layer, said first layer and said second layer being adjacently positioned in the information recording carrier,
means for performing radial tracking on the reflected light from the information recording carrier, and
means for assessing from said radial tracking if the light is focussed on a clockwise or a counter-clockwise oriented spiral relative to the light.

The apparatus may advantageously also comprise means for associating the orientation of the spiral with an indication of the identity of the layer on which the light is focussed.

In a third aspect, the invention relates to a computer program product being adapted to enable a computer system comprising at least one computer having data storage means associated therewith to control an optical recording apparatus according to the information reproducing method of the first aspect.

This aspect of the invention is particularly, but not exclusively, advantageous in that the present invention may be implemented by a computer program product enabling a computer system to control the operations of an apparatus according to the second aspect of the invention. Thus, it is contemplated that some known optical apparatus may be changed to operate according to the present invention by installing a computer program product on a computer system controlling the said optical apparatus. Such a computer program product may be provided on any kind of computer readable medium, e.g. magnetically or optically based medium, or through a computer based network, e.g. the Internet.

The first, second and third aspects of the present invention may each be combined with any of the other aspects. These and other aspects of the invention will be apparent from and elucidated with reference to the embodiments described hereinafter.

The present invention will now be explained with reference to the accompanying Figures, where

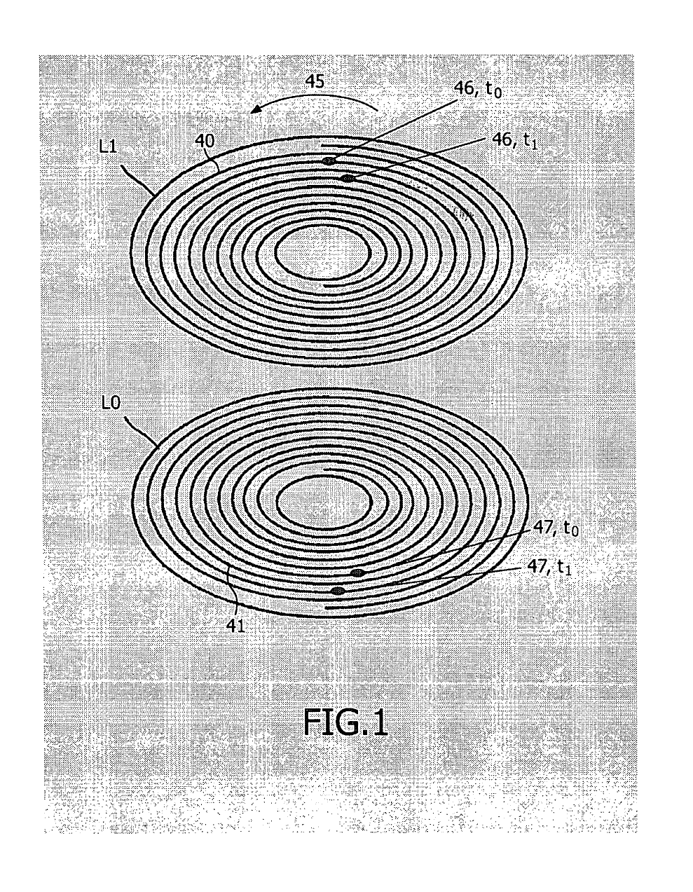

FIG. 1 shows a schematic exploded view of two information recording layers of a carrier with opposite oriented spirals,

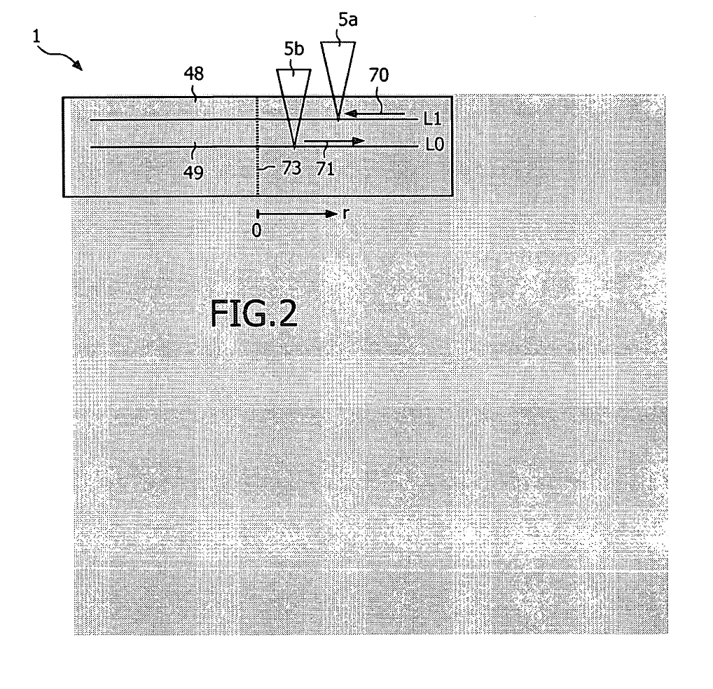

FIG. 2 shows a cross-sectional side-view of two information recording layers of a carrier with opposite oriented spirals,

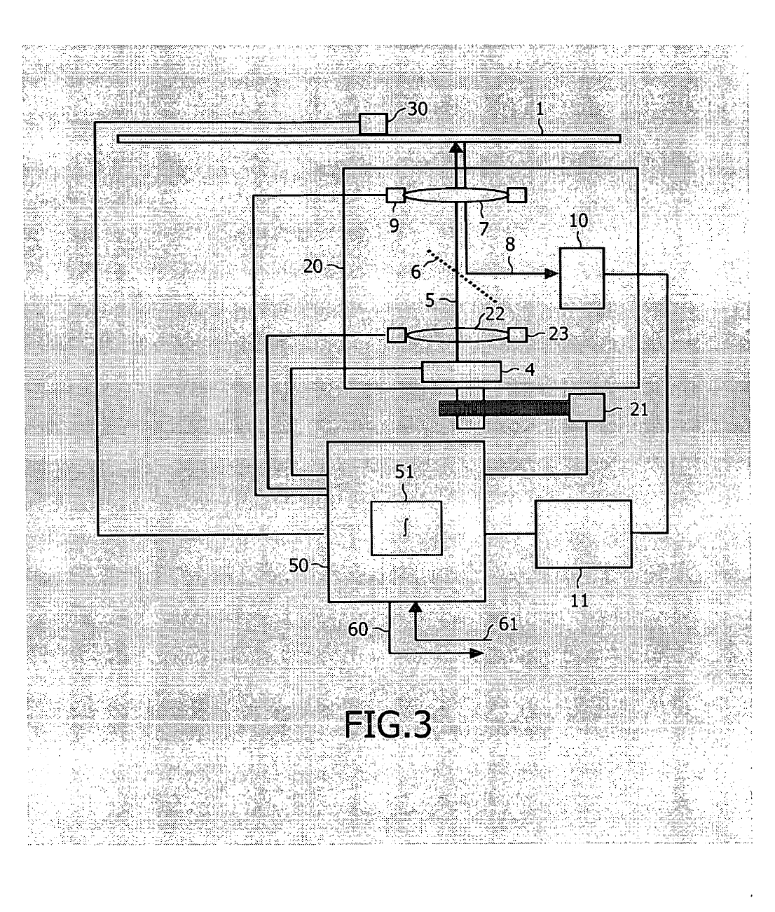

FIG. 3 shows an optical apparatus according to the second aspect of the invention, and

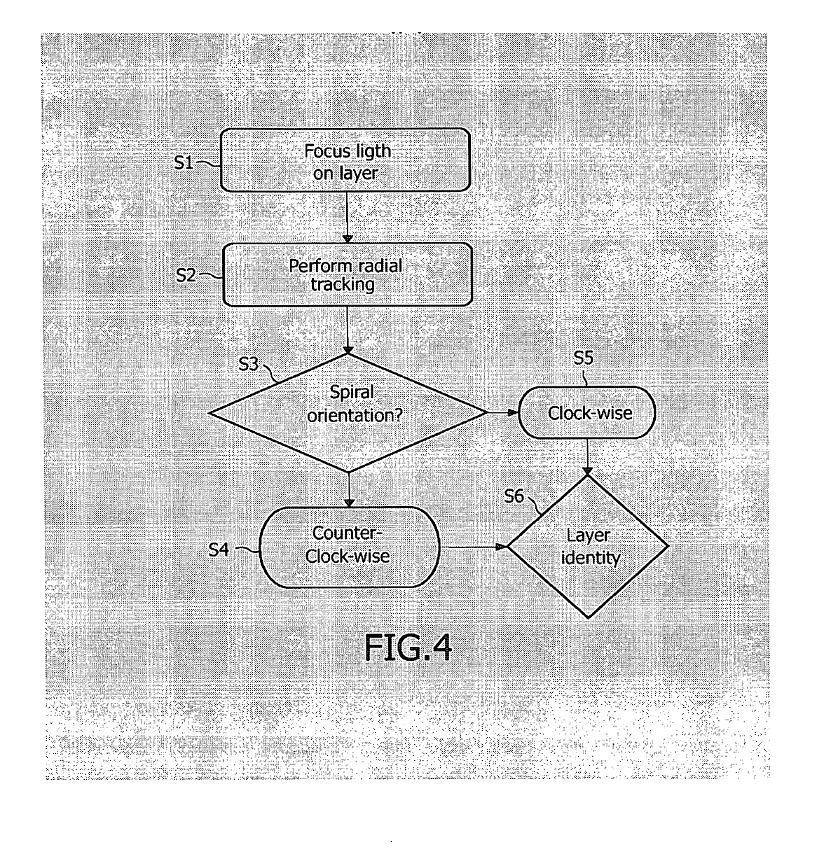

FIG. 4 is flow-chart illustrating the information reproducing method according to the first aspect of the invention.

FIG. 1 shows a schematic exploded view of two information recording layers L1 and L0 of a carrier 1. As shown the two recording layers L1 and L0 both comprise one spiral 40 and 41, respectively, and the spirals 40 and 41 are oppositely oriented. Thus, the spiral 40 of layer L1 is clockwise oriented as viewed in FIG. 1, whereas the spiral 41 of layer L0 is counter-clockwise oriented as viewed in FIG. 1.

The arrow 45 indicates the rotation of the carrier 1 during information reproduction. As will be apparent from the following detailed part of the description the rotation of the carrier 1 may provided by a optical apparatus capable of rotating the carrier 1 while the optical apparatus is reproducing information or preparing for reproducing information from the carrier 1.

In a first situation illustrated on layer L1, the light is focussed into a light spot 46 on the layer L1 at an initial time t₀. The light spot 46 will, due to the performed radial tracking, during rotation of the carrier 1 maintain a position substantially on the track of the spiral 40. The track of the spiral 40 may additionally be wobbled in order to provide additional information, preferably address information of data, but for clarity this is not illustrated in FIG. 1. Due to the combination of the rotational direction 45 and the orientation of the spiral 40, i.e. clockwise, the focussed light 46 will at a later time t₁ be positioned closer to a central position of the carrier 1 relative to the initial time tₒ. Thus, the light spot 46 is displaced inwards on the layer L1.

In a second situation illustrated on layer L0, the light is focussed into a light spot 47 on the layer L0 at an initial time t₀. The light spot 47 will, due to the performed radial tracking, during rotation of the carrier 1 maintain a position substantially on the track of the spiral 41. Due to the combination of the rotational direction 45 and the orientation of the spiral 41, i.e. counter-clockwise, the focussed light 47 will at a later time t₁ be positioned further away from a central position of the carrier 1 relative to the initial time tₒ. Thus, the light spot 47 is displaced outwards on the layer L1.

In FIG. 1, the principle of the invention is illustrated by two embodiments where the light spots 46 and 47 are displaced approximately inwards or outwards two revolutions on the respective spirals 40 and 41. However, this is purely for illustrative purposes. In fact, the principle of the present invention may applied for any number of revolutions, e.g. one, three, four, five or more, and also for fractions of one revolution, e.g. 1/10, ⅕, ⅓ etc., provided that a reliable and/or sufficient assessment of the spiral orientation of the spirals 40 and 41 is obtained.

FIG. 2 shows a cross-sectional side-view of two information recording layers of a carrier 1 with two layers L1 and L0 similar to the exploded view of FIG. 1. Thus, the two layers L1 and L0 have opposite oriented spirals.

In FIG. 2, a focussed light beam 5a, e.g. a laser beam focussed by an objective lens (not shown), is shown in a first situation where the light beam 5a is focussed on the layer L1 through a cover layer 48 of the carrier 1. As the carrier 1 rotates the light beam 5a will keep tracking the spiral 40 (not visible in the side view) of the layer L1 and thereby perform an radially inwards displacement towards a central position 73 on the carrier 1 as indicated by the arrow 70.

Similarly, there is also shown a light beam 5b focussed on the layer L0 through the cover layer 48 and the intermediate layer 49 separating the layers L1 and L0. As the carrier 1 rotates the light beam 5b will keep tracking the spiral 41 (not visible in the side view) of the layer L0 and thereby perform an radially outwards displacement towards a peripheral position on the carrier 1 as indicated by the arrow 71. The light beams 5a and 5b are in FIG. 2 shown as two distinct beams, but in a typical optical drive there will only be one main beam, where the main beam will have a variable focal position, i.e. the main beam can change from a position corresponding to beam 5a to beam 5b and vice versa.

The radial displacement of the light beam 5a or 5b is readily quantified if a radial coordinate system is introduced as shown in FIG. 2. The origo O of the radial coordinate system is positioned substantially at a central position of the carrier 1. A light beam 5a or 5b may then be described by a radial coordinate r. An incremental change Δr in the radial position r may be given by:

Δr=r(t₁)−r(t₀),

where t₀ indicates an initial time and t₁ a later time. Thus, for an inwards displacement the incremental change Δr is negative, whereas an outwards displacement has a positive incremental change Δr. The incremental change Δr may be averaged over time, differential time (i.e. Δt=t₁−t₀) or revolutions of the carrier 1 by various means, e.g. electronically, mechanically etc., as it may readily be performed by a skilled person once the general principle of the invention is appreciated. As it will be explained below the incremental change Δr may also be obtained by indirect ways, e.g. by measuring apparatus values or signals associated with or resulting from the radial tracking performed.

FIG. 3 shows an optical apparatus according to the second aspect of the invention with an optical recording carrier 1. The carrier 1 is fixed and rotated by holding means 30.

The carrier 1 may comprise a material suitable for recording information by means of a radiation beam 5. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier 1. Alternatively, protrusions in a reflective layer made of e.g. aluminum or silver may provide optically readable effect as with read-only media.

The apparatus comprises an optical head 20, the optical head 20 being displaceable by actuation means 21, e.g. an electric stepping motor. The optical head 20 comprises a photo detection system 10, a radiation source 4, a beam splitter 6, an objective lens 7, and lens displacement means 9. The beam splitter 6 for diverging the reflected radiation 8 into the photo detection means 10 may be a polarising or a non-polarising type, or a hologram or a grating. The optical head 20 also comprises beam splitting means (not shown), such as a grating or a holographic pattern that is capable of splitting the radiation beam 5 into at least three components for use in the three spot differential push-pull radial tracking control method. For reason of the clarity the radiation beam 5 is shown as a single beam. Similarly, the radiation 8 reflected also comprises more than one component but only one beam 8 is shown in FIG. 3 for clarity. The lens displacement means 9 is of the so-called three-dimensional type capable of displacing the lens 7 of course in the focal direction (z-direction) but also capable of displacing the lens 7 in the radial direction of the carrier 1. Additionally, the lens displacement 9 is capable of pivoting or tilting the lens 7 slightly around an axis being positioned in a plane substantially parallel to the carrier 1 and in a direction orthogonal to a radial direction of the carrier 1 in order to compensate e.g. “umbrella-like” defect of the carrier 1.

The optical head 20 also comprises collimator means, i.e. a collimator lens 22, for changing the diverging light 5 emitted from the radiation source 4 from a point source to a parallel beam 5. For reasons of clarity this is however not visible in FIG. 3. The collimator lens 22 is displaceable substantially along the optical axis of the beam 5 by dedicated actuation means 23, i.e. an electric stepping motor. This provides the possibility for compensating for the spherical aberration introduced by the cover layer 48 and the intermediate layer 49 shown in FIG. 2. In a particular embodiment of the invention, the collimator means are pre-set to a position in-between, preferably in the middle of the intermediate layer 49. If e.g. the layer L1 is has a distance from the surface where the light 5 enters the carrier 1 of 75 micrometer, and the layer L0 has a distance from the surface where the light 5 enters the carrier 1 of 100 micrometer, the collimator lens 22 may be set for compensating at distance of approximately 87.5 micrometer. This is of course not the optimal distance for compensating spherical aberration but during start up before information reproduction is initiated it may be unknown exactly what layer the light beam 5 is focused on and accordingly the best solution may be a compensating distance in-between the layers L1 and L0. The collimator means can also to some extent compensate or correct for focus offset.

In the embodiment shown in FIG. 3, the collimator means is a collimator lens but collimator means may also comprise one or more liquid-crystal (LC) cells before the objective lens 7, or one or more telescopic lenses between the beam splitter 6 and the objective lens 7.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals that are transmitted to a pre-processor 11. The photo detectors are arranged spatially to one another, and with a sufficient time resolution so as to enable detection of focus error and radial tracking errors in the pre-processor 11 similar to the optical drive setup shown in e.g. US 2004/0095860. Thus, the pre-processor 11 transmits focus error and radial tracking error signals to the processor 50. The photo detection system 10 can also transmit a read signal or RF signal representing the information being read from the carrier 1 to the processor 50 through the pre-processor 11.

Several methods are available for obtaining the error in a radial direction, i.e. the deviation from the actual radial position relative to the intended or ideal radial position, one such method being the push-pull (PP) method where a tracking error signal is generated on the basis of the level difference between optical signals detected in an optical sensor of the optical reproducing apparatus. Another option is the differential time (or phase) detection (DTD) method, wherein a phase difference between the optical signals detected in the optical sensors of the optical reproducing apparatus is applied for generating a radial tracking error signal. The DTD method was originally introduced by Braat as disclosed in U.S. Pat. No. 4,057,833. State-of-the-art differential PP methods apply the 3-spot method where a main light beam follows the track of information and two auxiliary light beams are shifted in opposite directions relative to the track, but any suitable method for performing radial tracking by a closed loop control mechanism so as to keep the focussed light 5 on the intended radial position on the carrier 1 may be adapted within the context of the present invention.

The radiation source 4 for emitting a radiation beam 5 can for example be a semiconductor laser with a variable power, possibly also with variable wavelength of radiation. Alternatively, the radiation source 4 may comprise more than one laser.

The optical head 20 is optically arranged so that the radiation beam 5 is directed to the optical carrier 1 via the collimator lens 22, the beam splitter 6, and the objective lens 7. Radiation 8 reflected from the carrier 1 is collected by the objective lens 7 and, after passing through the beam splitter 6, falls on a photo detection system 10 which converts the incident radiation 8 to electric output signals as described above.

The processor 50 receives and analyses output signals from the pre-processor 11. The processor 50 can also output control signals to the actuation means 21, the radiation source 4, the lens displacement means 9, the collimator actuation means 23, the pre-processor 11, and the holding means 30, as illustrated in FIG. 1. Similarly, the processor 50 can receive data, e.g. information to be written on the carrier 1, indicated at 61, and the processor 50 may output data from the reading process as indicated at 60.

Assessment of the spiral orientation is performed from the radial tracking as indicated above. However, this assessment may be performed in various ways:

Firstly, the processor 50 can comprise an integrator or summation circuit 51 that adds up the radial tracking error signals received from the pre-processor 11 over a pre-defined period of time and/or revolutions of the carrier 1. The integrator 51 can output a signal, preferably a polarity signal (±1, 0/1 etc.), depending on the orientation of the spiral that the light 5 is focussed on.

Secondly, the average current of the control signal transmitted from the processor 50 to radial actuation means 21 can be measured and used as an indication of the orientation of the spiral the light 5 is focussed on. For practical reasons, the radial actuation is performed both by radial actuation means 21, e.g. a relatively coarse sledge motor, and by a more delicate radial displacement of the lens 7 with the lens displacement actuator 9. Both the fine-tuning actuator 9 and the sledge motor 21, and in particular their associated control and/or power currents, can be utilized for assessing the orientation of the spiral that the light 5 is focussed in. Measuring of any of the afore-mentioned currents can readily be measured by means well known to a skilled person; e.g. dedicated ampere-meters may be inserted.

FIG. 4 is flow-chart illustrating the information reproducing method according to the first aspect of the invention.

In a first step S1, light 5 is focussed at a first information layer L1 or a second information layer L0. The first layer L1 and the second layer L0 may be adjacently positioned in the information recording carrier as shown in FIG. 2.

In a second step S2, there is performed radial tracking on the reflected light 8 from the information recording carrier 1 as explained above. Thus, the focussed light 5 is kept in a track by a closed loop control mechanism, the track being disposed as a spiral 40 or 41 depicted in FIG. 1.

In a third step S3, the radial tracking is exploited to assess if the light 5 is focussed on a clockwise or a counter-clockwise oriented spiral relative to the light 5. This may be done in a particular embodiment by integrating and preferably averaging the radial error tracking signal transmitted to the processor 50 in the integrator circuit 51.

Depending on the orientation of the spiral 40 or 41 there is provided a value indicative of a clockwise orientation S5 or a counter-clockwise orientation S4.

In the sixth step S6, the value indicative of the spiral orientation is utilized for identifying the layer L1 or L0 on which the light 5 is focussed. The may be done in absolute manner or in a relative manner, where the latter situation corresponds to e.g. a carrier with more than two or three layers.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An information reproducing method of reproducing information recorded on an information recording carrier (1), the carrier having a plurality of information layers (L1, L0), each layer having information arranged in one or more substantially concentric spiral(s), by radiating light (5) onto the information recording carrier (1), the method comprising the steps of:
focusing the light (5) at a first information layer (L1) or a second information layer (L0), said first layer and said second layer being adjacently positioned in the information recording carrier (1),
performing radial tracking on the reflected light (8) from the information recording carrier (1), and
assessing from said radial tracking if the light (5) is focussed on a clockwise or a counter-clockwise oriented spiral (40, 41) relative to the light (5).

2. An information reproducing method according to claim 1, wherein assessment of whether the light (5) is focussed on a clockwise or a counter-clockwise oriented spiral (40, 41) relative to the light is indicative for the identity of the layer (L1, L0) on which the light is focussed.

3. An information reproducing method according to claim 1 further comprising an initial step of compensating for optical aberration at a position in the optical record carrier in-between said first layer and said second layer (L1, L0).

4. An information reproducing method according to claim 3, wherein said position for the optical aberration compensation is substantially in a middle position relative to said first layer (L1) and said second layer (L0).

5. An information reproducing method according to claim 1, wherein the step of assessing from said radial tracking if the light (5) is focussed on a clockwise or a counter-clockwise oriented spiral (40, 41) relative to the light (5) comprises measuring of an incremental radial displacement (Δr) of the relative position of the light (5) on the information recording carrier (1).

6. An information reproducing method according to claim 5, wherein said incremental radial displacement (Δr) is measured by radial integration means (51).

7. An information reproducing method according to claim 4, wherein said incremental radial displacement is measured from actuation means (9, 21) adapted for displacing the relative position of the light (5) on the information recording carrier (1).

8. An information reproducing method according to claim 5, wherein the measured incremental radial displacement (Δr) is averaged over at least one revolution of the information recording carrier (1).

9. An information reproducing method according to claim 1, wherein the performed radial tracking on the reflected light (8) from the information recording carrier (1) is based on a radial tracking method comprised in the group of: push-pull (PP), differential push-pull (DPP) and differential phase detection (DPD).

10. An information reproducing method according to claim 1, wherein at least one spiral (40) of the first layer (L1) and at least one spiral (41) of the second layer (L0) are oriented in opposite directions relative to the light (5).

11. An optical apparatus adapted for reproducing and/or recording information from/to an optical information carrier (1), the optical apparatus comprising:
means (7) for focusing the light (5) at a first information layer (L1) or a second information layer (L0), said first layer and said second layer being adjacently positioned in the information recording carrier (1),
means (10, 11, 50, 21) for performing radial tracking on the reflected light (8) from the information recording carrier (1), and
means (50, 51) for assessing from said radial tracking if the light is focussed on a clockwise or a counter-clockwise oriented spiral relative to the light

12. A computer program product being adapted to enable a computer system comprising at least one computer having data storage means associated therewith to control an optical apparatus according to the information reproducing method as claimed in claim 1.
